(19) United States
(12) Patent Application Publication
(10) Pub. No.: US 2025/0216663 A1
(43) Pub. Date: Jul. 3, 2025

(54) MICROSCOPY ASSEMBLIES

(71) Applicant: IDEXX Laboratories, Inc., Westbrook, ME (US)

(72) Inventors: Philip N. Harju, Bridgton, ME (US); John H. McGibbon, Old Orchard Beach, ME (US); Spencer Franklin McElwain, Sacco, ME (US); Stephan Hersey, Scarborough, ME (US); Caleb Sheehan Niles, Portland, ME (US); Jason Harris Karp, Portland, ME (US); Michael R. Moon, Scarborough, ME (US)

(73) Assignee: IDEXX Laboratories, Inc., Westbrook, ME (US)

(21) Appl. No.: 18/999,341

(22) Filed: Dec. 23, 2024

Related U.S. Application Data
(60) Provisional application No. 63/614,979, filed on Dec. 27, 2023.

(51) Int. Cl. G02B 21/26; G02B 21/28; G02B 21/34; G02B 21/36

(52) U.S. Cl. CPC G02B 21/26; G02B 21/28; G02B 21/34; G02B 21/362

(57) ABSTRACT

A microscopy assembly includes: a stage for receiving an optical cartridge, the stage comprising: a platform defining a planar surface and a window extending through the platform, and a retention arm defining a retention face and a rounded release face opposite the retention face, wherein the retention face at least partially faces the planar surface of the platform and is configured to engage a complementary cartridge engagement surface of the optical cartridge inserted into the microscope assembly.

### CROSS-REFERENCE TO RELATED APPLICATION

This application claims the benefit of co-pending U.S. Provisional Patent Application No. 63/614,979, filed Dec. 27, 2023, for “Microscopy Assemblies,” which is hereby incorporated by reference in its entirety including the drawings.

### BACKGROUND

### Field

The present disclosure generally relates to microscopy assemblies, and more specifically, to microscopy assemblies having any, some, or all of a stage having a retention arm and a pair of biased compression members, an optical target, an objective dust cover, and/or a sensor and a sensing target.

### Technical Background

Optical systems of microscope assemblies require calibration. Moreover, placement of a microscope stage of the microscope assembly with respect to other components of the microscope assembly, such as the objective lens or objective lenses, is important to interrogate samples on the microscope stage. In some circumstances, such as when microscope assemblies are utilized at a point-of-care, the microscope assemblies may spend much of the time not in use, and components of the microscope assembly, such as the objective lens can collect debris or dust, impacting the performance of the microscope assembly. In some instances, such as when interrogating biological samples, it is necessary to maintain specific orientation of the sample with respect to components of the microscope assembly and the biological sample may need to be maintained at certain environmental conditions, such as temperature and the like. Accordingly, a need exists for improved microscope assemblies.

### SUMMARY

According to one embodiment a microscopy assembly includes: a stage for receiving an optical cartridge, the stage comprising: a platform defining a planar surface and a window extending through the platform; and a retention arm defining a retention face and a rounded release face opposite the retention face, wherein the retention face at least partially faces the planar surface of the platform and is configured to engage a complementary cartridge engagement surface of the optical cartridge inserted into the microscope assembly.

According to another embodiment, a microscopy assembly includes: a stage for receiving an optical cartridge, the stage comprising: a platform defining a planar surface and a window extending through the platform, a retention arm defining a retention face and a rounded release face opposite the retention face, wherein the retention face at least partially faces the planar surface of the platform and is configured to engage a complementary cartridge engagement surface of the optical cartridge inserted into the microscope assembly; and an optical target.

According to another embodiment, a microscopy assembly includes: a stage for receiving an optical cartridge, the stage comprising: a platform defining a planar surface and a window extending through the platform, a retention arm defining a retention face and a rounded release face opposite the retention face, wherein the retention face at least partially faces the planar surface of the platform and is configured to engage a complementary cartridge engagement surface of the optical cartridge inserted into the microscope assembly; and an objective dust cover coupled to the stage.

According to another embodiment, a microscopy assembly includes: a stage for receiving an optical cartridge, the stage comprising: a platform defining a planar surface and a window extending through the platform, a retention arm defining a retention face and a rounded release face opposite the retention face, wherein the retention face at least partially faces the planar surface of the platform and is configured to engage a complementary cartridge engagement surface of the optical cartridge inserted into the microscope assembly; a sensor; and a sensing target, wherein: one of the sensor and the sensing target is fixed to the stage, and the other of the sensor and the sensing target is spaced apart from the stage.

Additional features and advantages of the aspects described herein will be set forth in the detailed description which follows, and in part will be readily apparent to those skilled in the art from that description or recognized by practicing the aspects described herein, including the detailed description, which follows, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts a top perspective view of a sample stage of a microscopy assembly and motor assemblies, positioning arms, and sensor assemblies for the positioning of the sample stage, according to one or more embodiments shown and described herein;

FIG. 2A schematically depicts a side view of a sensor and a sensing target coupled to a positioning arm of the microscope assembly of FIG. 1, according to one or more embodiments shown and described herein;

FIG. 2B schematically depicts a top view of sensor and a sensing target of the microscope assembly of FIG. 1, according to one or more embodiments shown and described herein;

FIG. 3 schematically depicts a top view of a cartridge holder of a stage of the microscope assembly of FIG. 1, according to one or more embodiments shown and described herein;

FIG. 4 schematically depicts a bottom view of a platform and a cartridge holder of a stage of the microscope assembly of FIG. 1, according to one or more embodiments shown and described herein;

FIG. 5A schematically depicts an objective dust cover coupled to the stage of the microscope assembly of FIG. 1, according to one or more embodiments shown and described herein;

FIG. 5B schematically depicts another objective dust cover, according to one or more embodiments shown and described herein;

FIG. 6 schematically depicts an objective lens and a stage of the microscope assembly of FIG. 1, according to one or more embodiments shown and described herein;

FIG. 7A schematically depicts an optical target sample and an optical target optical cartridge on the stage of the microscope assembly of FIG. 1, according to one or more embodiments shown and described herein;

FIG. 7B schematically depicts a plurality of patterns on an optical target optical cartridge, according to one or more embodiments shown and described herein;

FIG. 7C schematically depicts a pinhole aperture of an optical target sample, according to one or more embodiments shown and described herein; and

FIG. 8 depicts an image of a pinhole aperture of an optical target sample, according to one or more embodiments shown and described herein.

### DETAILED DESCRIPTION

The present disclosure, in one form, is related to microscopy assemblies, and, particularly, to microscopy assemblies having any, some, or all of a stage having a retention arm and a pair of biased compression members, an optical target, an objective dust cover, and/or a sensor and a sensing target. In embodiments, microscopy assemblies described herein include a stage having a retention arm and a pair of biased compression members. In embodiments, microscopy assemblies described herein include a stage having a retention arm and a pair of biased compression members and an optical target. In embodiments, microscopy assemblies described herein include a stage having a retention arm and a pair of biased compression members and an objective dust cover. In embodiments, microscopy assemblies described herein include a stage having a retention arm and a pair of biased compression members, a sensor, and a sensor target. In embodiments, microscopy assemblies described herein include a stage having a retention arm and a pair of biased compression members, an optical target, and an objective dust cover. In embodiments, microscopy assemblies described herein include a stage having a retention arm and a pair of biased compression members, an optical target, a sensor, and a sensing target. In embodiments, microscopy assemblies described herein include a stage having a retention arm and a pair of biased compression members, an optical target, an objective dust cover, a sensor, and a sensing target. In embodiments, microscopy assemblies described herein include a stage having a retention arm and a pair of biased compression members, an objective dust cover, a sensor, and a sensing target. In embodiments, microscopy assemblies described herein include an optical target. In embodiments, microscopy assemblies described herein include an optical target and an objective dust cover. In embodiments, microscopy assemblies described herein include an optical target, a sensor, and a sensing target. In embodiments, microscopy assemblies described herein include an optical target, an objective dust cover, a sensor, and a sensing target. In embodiments, microscopy assemblies described herein include an objective dust cover. In embodiments, microscopy assemblies described herein include an objective dust cover, a sensor, and a sensing target. In embodiments, microscopy assemblies described herein include a sensor and a sensing target.

Microscopy assemblies described herein may improve upon conventional microscopy assemblies in that, in embodiments, microscopy assemblies described herein may include an optical target including a pinhole aperture. In embodiments, a pinhole aperture of an optical target may be inexpensively created (by, for example, boring a hole in an optical sample). In embodiments, a pinhole aperture of an optical target of a microscopy assembly may advantageously provide a mechanism for making resolution measurements of such optical devices. In embodiments, an optical target comprising a pinhole aperture may be integrally formed from or otherwise attached to a stage or other component of a microscopy assembly, advantageously enabling calibration and/or measurement of resolution of one or more optical device(s) of the microscopy assembly throughout the lifespan of the microscopy assembly.

Microscopy assemblies described herein may improve upon conventional microscopy assemblies in that, in embodiments, microscopy assemblies described herein may include an optical target having one or more patterns and/or features that may be used to make resolution measurements of one or more optical device(s) of such microscopy assemblies. In embodiments, optical targets having such patterns and/or features may, advantageously, be integrally formed from a stage or other component of such microscopy assemblies and/or provided on an optical cartridge of such microscopy assemblies, thereby advantageously enabling calibration and/or measurement of resolution of one or more optical device(s) of the microscopy assembly throughout the lifespan of the microscopy assembly. Advantageously, in embodiments, optical targets having such patterns and/or features may be periodically inspected and compared against, for example, an optical target of known quality to ensure that calibration and/or resolution measurements made from such optical targets are within an acceptable accuracy threshold.

Microscopy assemblies described herein may improve upon conventional microscopy assemblies in that, in embodiments, microscopy assemblies described herein may include an objective dust cover. In embodiments, such an objective dust cover may advantageously be attached to a stage or other component of a microscopy assembly to, for example, shield an optical device (for example, an objective lens) of the microscopy assembly from dust while not in use.

Microscopy assemblies described herein may improve upon conventional microscopy assemblies in that, in embodiments, microscopy assemblies described herein may include a sensor and a sensing target. Such a sensor and a sensing target may be used to position and/or detect the position of a stage or other component of a microscopy assembly (in, for example, either or both of an x- and/or y-coordinate scheme). In embodiments, either such sensors or such sensing targets may be directly attached to the stage or other component, thereby advantageously enabling the direct measurement of a position of the stage or other component and/or reducing a part count and/or assembly time of a microscopy assembly thereof. In embodiments, such sensors may provide an absolute measurement of a position of the stage or other component, thereby advantageously not requiring the need of a reference input and/or a homing process and/or device (for example, a positional feedback process and/or device) to measure a position of the stage or other component. In embodiments, such sensors may continue to provide an electronic feedback signal even if power to the sensor is disconnected or interrupted, thereby advantageously providing a positioning mechanism for which the function has a reduced reliance on constant and/or uninterrupted power.

Microscopy assemblies described herein may improve upon conventional microscopy assemblies in that, in embodiments, microscopy assemblies described herein may include a cartridge holder which may hold a cartridge to a stage of such microscopy assemblies and/or position a heatsink and/or heater to control a temperature of a sample of such microscopy assemblies during imaging. In embodiments, the cartridge holder may be a single injection molded part, thereby advantageously reducing part count and/or manufacturing time of such microscopy assemblies, reducing a cost associated with manufacturing a mechanism for holding the cartridge to the stage and/or a mechanism for positioning a heatsink and/or heater near the sample, and/or positioning the sample such that a sampling plane defined by the sample is substantially parallel to a focusing plane of an optical device (for example, an objective lens) of such microscopy assemblies.

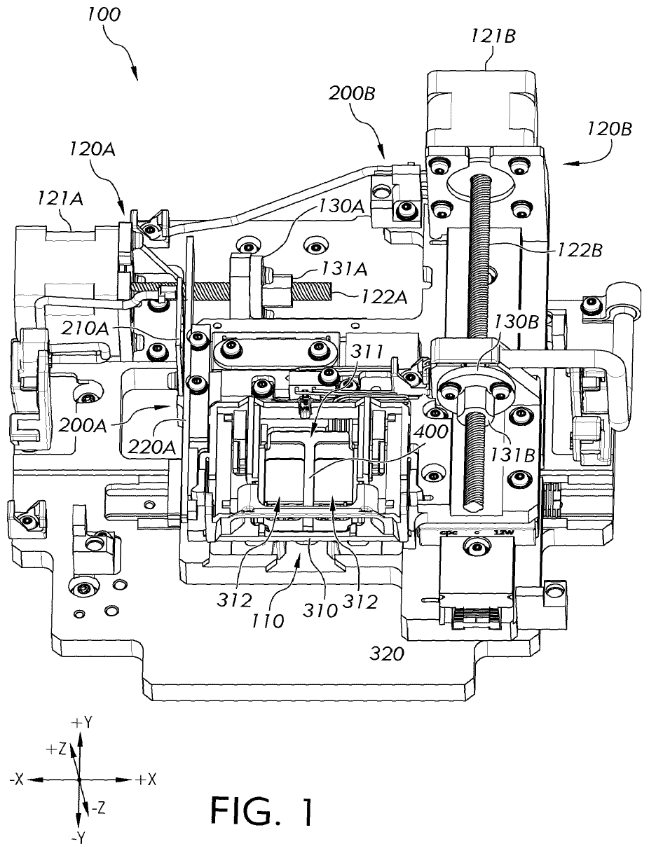

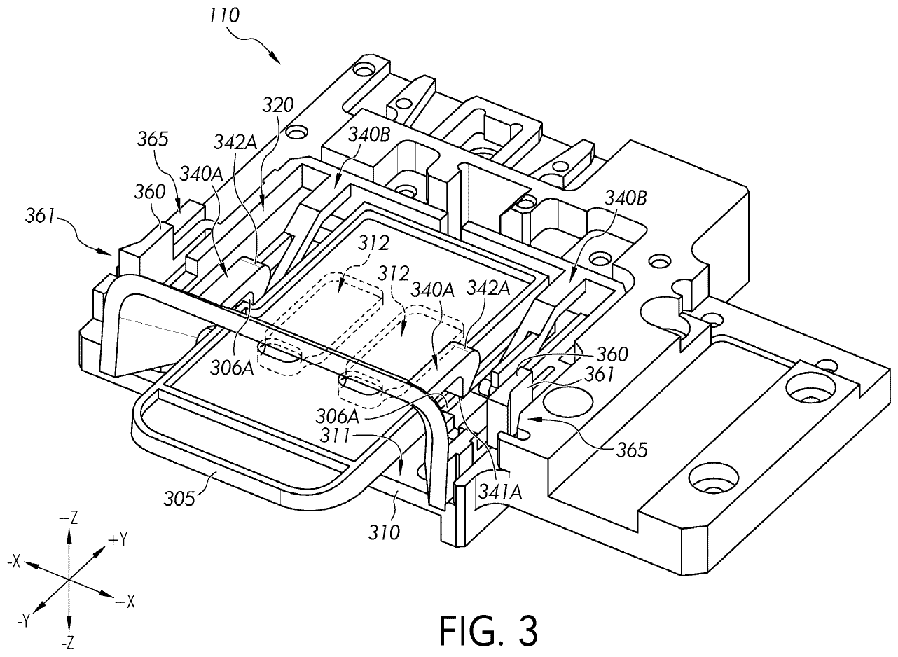

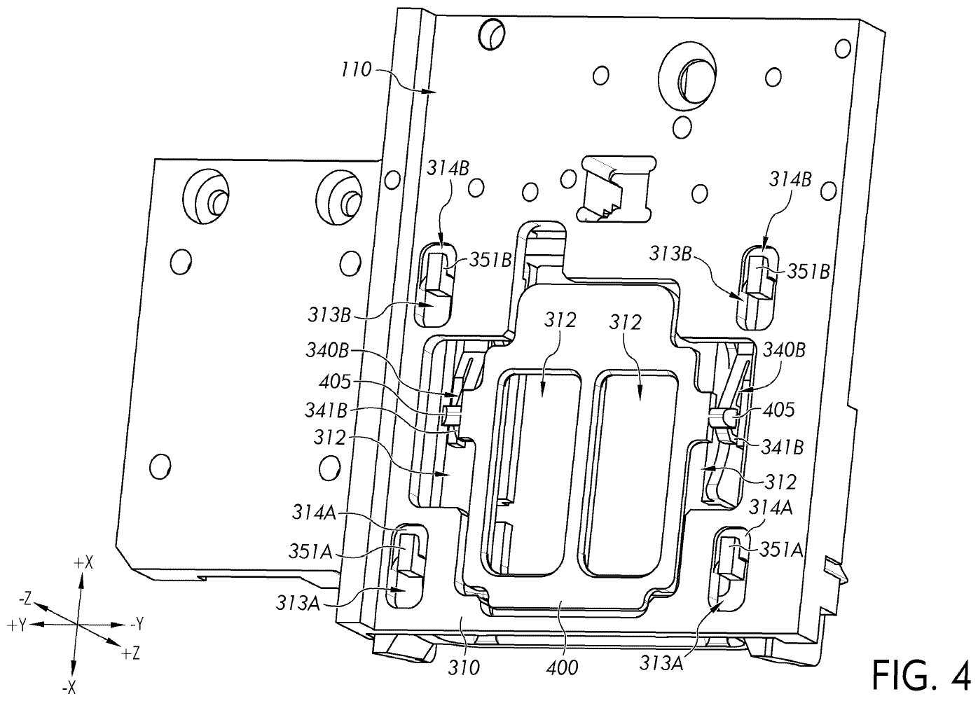

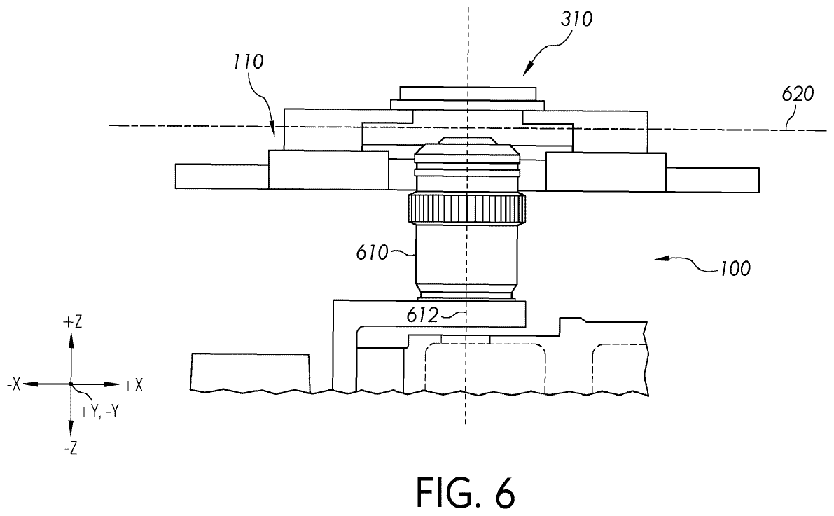

Turning now to the drawings, FIG. 1 depicts an embodiment of a microscopy assembly 100, which includes a stage 110. In embodiments, the stage 110 includes a platform 310 which defines a planar surface 311 and a window 312 extending through the platform 310. In embodiments, an optical cartridge (for example, an optical cartridge 305, depicted in FIG. 3 and described elsewhere herein) may be received by the stage 110 and positioned upon the platform 310 to be viewed by an optical device (for example, one or more lens(es), mirror(s), and/or light source(s), such as an objective lens 610, depicted in FIG. 6 and described elsewhere herein) of the microscopy assembly 100. In embodiments, the optical cartridge made be held in place by a cartridge holder 320, which is described in further detail elsewhere herein with reference to FIGS. 3-4.

To view an optical cartridge received by the stage 110, the optical cartridge (and, thereby, at least some of the stage 110) must be optically coupled to an optical device (for example, an objective lens 610, depicted in FIG. 6 and described elsewhere herein). The term “optically coupled,” as used herein with reference to one or more optical devices and one or more other component(s) (for example, one or more other optical device(s) and/or an optical cartridge) are positioned, oriented, and/or designed such that an optical signal (for example, for example, visible light, ultraviolet light, blue light, white light, fluorescence light, infrared light, other electromagnetic waves, and/or any combination thereof) the one or more optical device(s) and the one or more other components may be propagated therebetween. Further, optical devices and/or components may be said to be “optically coupled” when each device and/or component is within the same optical path of an optical signal transmitted between, through, to, and/or from the devices and/or components. Accordingly, the term “optical path” when used herein with respect to an optical signal is the path of the optical signal transmitted by, to, from, between, and/or through one or more devices and/or components.

Accordingly, in embodiments, a process for optically coupling an optical device of the microscopy assembly 100 with the stage 110 may include moving the stage 110 (for example, in either or both of the +/−x- and/or +/−y-directions of the coordinate scheme of FIG. 1). Accordingly, in embodiments, the microscopy assembly 100 may include either or both of a first motor assembly 120A (which may, in embodiments, move the stage 110 in the +/−x-direction of the coordinate scheme of FIG. 1) and/or a second motor assembly 120B (which may, in embodiments, move the stage 110 in the +/−y-direction of the coordinate scheme of FIG. 1).

In embodiments, the first motor assembly 120A may move the stage 110 by operating a first motor 121A to rotate a first motor shaft 122A. In embodiments, the first motor shaft 122A may be mechanically coupled to a first positioning arm 130A of the stage 110, by being positioned within a first positioning arm nut 131A of the first positioning arm 130A. In embodiments, both the first motor shaft 122A and the first positioning arm nut 131A may be threaded such that rotation of the first motor shaft 122A moves the first positioning arm nut 131A (and, thereby, the first positioning arm 130A and the stage 110) along the first motor shaft 122A (for example, in motion parallel to the x-axis of FIG. 1).

In embodiments, the second motor assembly 120B may move the stage 110 by operating a second motor 121B to rotate a second motor shaft 122B. In embodiments, the second motor shaft 122B may be mechanically coupled to a second positioning arm 130B of the stage 110, by being positioned within a second positioning arm nut 131B of the second positioning arm 130B. In embodiments, both the second motor shaft 122B and the second positioning arm nut 131B may be threaded such that rotation of the second motor shaft 122B moves the second positioning arm nut 131B (and, thereby, the second positioning arm 130B and the stage 110) along the second motor shaft 122B (for example, in motion parallel to the y-axis of FIG. 1).

In embodiments, the microscopy assembly 100 may include only one motor assembly (for example, only one of the motor assemblies 120A, 120B). In embodiments, the microscopy assembly 100 may include any plurality of motor assemblies, such as three, four, or even five or more motor assemblies.

To precisely position the stage 110 and/or control either or both of the motor assemblies 120A, 120B, one or more sensors may be utilized to detect a position of the stage 110 (in, for example, either or both of the x- and/or y-coordinates of the coordinate scheme of FIG. 1). Accordingly, in embodiments, the microscopy assembly 100 may include either or both of a first sensor assembly 200A (for, example, measuring an x-coordinate of a position of the stage 110) and/or a second sensor assembly 200B (for, example, measuring a y-coordinate of a position of the stage 110). In embodiments, the sensor assemblies 200A, 200B may operate by sensing, with a sensor, a sensing target and determining, from a measurement generated by the sensing of the sensing target, a position of the stage. For example, in embodiments, the first sensor assembly 200A may include a first sensor 210A and a first sensing target 220A. In embodiments, the second sensor assembly 200B may also include a sensor and a sensing target (not identified in FIG. 1, due to view of such being obstructed by the stage 110 and the second motor assembly 120B).

In embodiments, the microscopy assembly 100 may include only one sensor assembly (for example, only one of the sensor assemblies 200A, 200B). In embodiments, the microscopy assembly 100 may include any plurality of sensor assemblies, such as three, four, or even five sensor assemblies. In embodiments, each motor assembly (for example, each of the motor assemblies 120A, 120B) may be associated with a respective sensor assembly (for example, the first sensor assembly 200A and the second sensor assembly 200B, respectively) for measuring a position of the stage 110 altered by each respective motor assembly. In embodiments, one or more motor assemblies (for example, each of the motor assemblies 120A, 120B) of the microscopy assembly 100 may be associated with any plurality of sensor assemblies. In embodiments, one or more motor assemblies (for example, each of the motor assemblies 120A, 120B) of the microscopy assembly 100 may be associated with no sensor assemblies. In embodiments, one or more motor assemblies (for example, the first motor assembly 120A) of the microscopy assembly 100 may be associated with a differing number of sensor assemblies than one or more other motor assemblies (for example, the second motor assembly 120B) of the microscopy assembly 100.

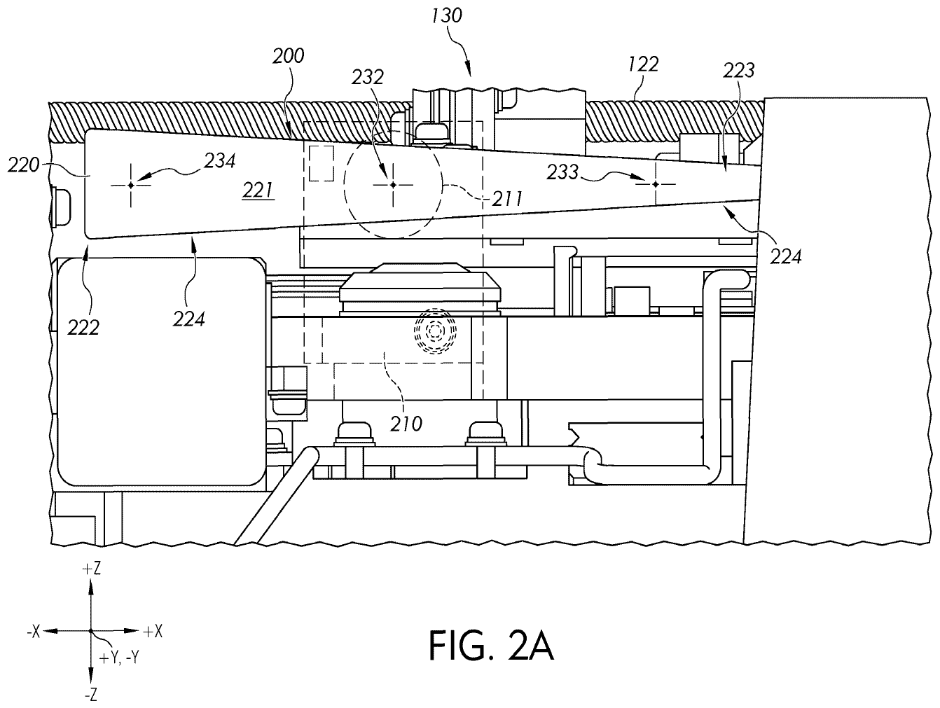

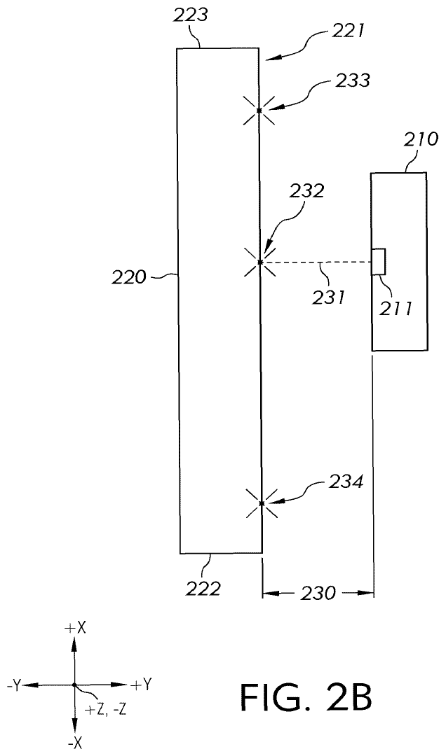

Referring now to FIGS. 2A-2B, in embodiments, either or both of the sensor assemblies 200A, 200B may be configured as a sensor assembly 200. In embodiments, a sensor 210 of the sensor assembly 200 may sense a sensing target 220 of the sensor assembly 200 to determine a position of a positioning arm 130 of a stage (for example, the stage 110) coupled to a motor shaft 122 (for example, either or both of the motor shafts 122A, 122B) of a motor assembly 120 (for example, either or both of the motor assemblies 120A, 120B).

In embodiments, the sensor 210 may be an inductance sensor and be and/or include a printed circuit board and a sensing coil 211 (for example, a wound coil formed from, for example, copper). Accordingly, in embodiments, the sensor 210 may use the sensing coil 211 to measure an inductance of the sensing coil 211 generated by the sensing target 220 (for example, a metal plate). In embodiments, the sensing target 220 may be mechanically coupled to the positioning arm 130 such that movement of the positioning arm 130 by the motor shaft 122 changes a sensing position of the sensor 210 defined by a position of a sensing axis 231 (extending across a spacing 230 between the sensor 210 and lateral face 221 of the sensing target 220) along a lateral face 221 of the sensing target 220 extending from a first end 222 of the sensing target 220 to a second end 223 of the sensing target 220 opposite the first end 222. Accordingly, in embodiments, movement of the positioning arm 130 may cause the sensing target 220 to be movable relative to the sensor 210 such that the sensing axis 231 is movable between the ends 222, 223 of the sensing target 220. In embodiments, a sensing position of the sensor 210 may, thereby, be movable along the lateral face 221 (in, for example, the +/−x-direction of the coordinate schemes of FIGS. 2A-2B) between the first end 222 and the second end 223 of the sensing target 220 such as between, for example, a first sensing position 232, a second sensing position 233, and a third sensing position 234.

While the embodiments of FIGS. 2A-2B depicts the sensing target 220 as being mechanically coupled to the positioning arm 130, in other embodiments, the sensor 210 may, instead, be mechanically coupled to the positioning arm 130. Further, in embodiments, either of the sensor 210 or the sensing target 220 may not be coupled to a positioning arm and may, instead, be otherwise mechanically coupled to a stage (for example, the stage 110) and/or any component thereof.

In embodiments, the lateral face 221 of the sensing target 220 may be substantially planar relative to the sensor 210 such that, in embodiments, the spacing 230 between the sensor 210 and the sensing target 220 may remain substantially constant despite movement of the positioning arm 130 (and, thereby, the sensing target 220). Accordingly, in embodiments, a variable inductance measured by the sensor 210 may be a function of a sensing position of the sensor 210 along the lateral face 221 of the sensing target 220 (as defined by the position of the sensing axis 231). However, in embodiments (such as, for example, embodiments wherein movement of the positioning arm 130 alters a magnitude of the spacing 230), a variable inductance may be a function of the magnitude of the spacing 230.

In embodiments, an inductance measured by the sensor 210 may be a function (at least in part) of a two-dimensional area of the lateral face 221 (and/or, in embodiments, any, some, or all of a plurality of two-dimensional areas, a volume, and/or other measure of the lateral face 221 and/or of the sensing target 220) in the vicinity of the sensing position of the sensor 210 along the lateral face 221. Depending on a sensing position of the sensor 210 along the lateral face 221, the two-dimensional area of the lateral face 221 in a vicinity of the sensing position may vary due to a sloped edge 224 of the lateral face 221. In embodiments, the sloped edge 224 may include a gradient which alters a magnitude of the two-dimensional area of the lateral face 221 in the vicinity of the sensing position of the sensor 210 as the sensing position moves along the lateral face 221 (for example, in movement parallel to the x-axis of FIGS. 2A-2B). For example, a magnitude of a two-dimensional area of the lateral face 221 in the vicinity of the first sensing position 232 may be greater than a magnitude of a two-dimensional area of the lateral face 221 in the vicinity of the second sensing position 233 and lesser than a magnitude of a two-dimensional area of the lateral face 221 in the vicinity of the third sensing position 234.

Since, in embodiments, an inductance measured by the sensor 210 from the sensing coil 211 may vary depending on an amount of the sensing target 220 in the vicinity of a sensing position of the sensor 210, varying two-dimensional areas (and/or, in embodiments, any, some, or all of a plurality of two-dimensional areas, a volume, and/or other measure of the lateral face 221 and/or of the sensing target 220) of the lateral face 221 in the vicinity of the sensing position of the sensor 210 may cause such variance in the inductance measured by the sensor 210. In embodiments, the sensor 210 may thereby measure a position of a stage (for example, the stage 110) as a function of an inductance measured from the sensing coil 211, as, in embodiments, the inductance measured from the sensing coil 211 may be indicative of a position of the stage. In embodiments, the sensor 210 may, thereby, not require a reference input and/or a homing process and/or device to determine a position of a stage, contrary to, for example, conventional optical positional sensors or other conventional positional sensors. Further, in embodiments, since the sensing coil 211 may generate a feedback signal even if power is interrupted to the sensor 210, measurement by the sensor 210 may not be affected by interruptions of power to the sensor 210 and/or may be affected to a lesser degree or only by greater interruptions than an effect experienced by interruptions of power to a conventional sensor (for example, an optical positional sensor).

In the embodiment of FIG. 2A, the gradient of the sloped edge 224 is a constant slope. Accordingly, in the embodiment of FIG. 2A, the sensing target 220 has a triangular geometry defined by the lateral face 221. However, in other embodiments, the gradient of the sloped edge 224 may include any, some, or all of a constant slope, a variable slope, one or more other slope(s), a step-wise gradient, one or more other gradient(s), and/or one or more other change(s) between the ends 222, 223. In embodiments, the sensing target 220 may have a gradient defined by any, some, or all of the sloped edge 224, the lateral face 221, and/or one or more other face(s) and/or edge(s) of the sensing target 220, and, in embodiments, a gradient defined by the sensing target 220 may be a gradient in any, some, or all directions, such as, for example, any, some, or all of the +/−x-, +/−y-, and/or +/−z directions of the coordinate schemes of FIGS. 2A-2B. In embodiments, the sensing target 220 may have any other geometry which may vary as the sensing target 220 moves (parallel to, for example, any, some, or all of the x-, y-, and/or z-axes of FIGS. 2A-2B). Further, in embodiments, the sensing target 220 may have any plurality of lateral faces sensed by the sensor 210, such as two, three, or even four or more lateral faces.

In embodiments, measurements of the sensor 210 (for example, inductance measurements) may vary with a temperature of the sensing coil 211. Accordingly, in embodiments, the sensor assembly 200 may also include a temperature sensor (for example, positioned on and/or electrically coupled to a circuit board of the sensor 210) which may measure a temperature of at least part of the sensor assembly 200 (for example, a temperature of the sensing coil 211 and/or a temperature of the sensing target 220). By measuring a temperature of at least part of the sensor assembly 200, variances in measurements (for example, inductance) of the sensor assembly 200 due to variances in temperature of components of the sensor assembly 200 may be used in calculating a position of a stage mechanically coupled to either or both of the sensor 210 and/or the sensing target 220, thereby, in embodiments, reducing and/or eliminating uncertainty in such measurements due to temperature variations of one or more component(s) of the sensor assembly 200.

While, in the embodiments of FIGS. 2A-2B, the sensor 210 is an inductance sensor, in other embodiments, the sensor 210 may be another sensor, such as, for example, an optical sensor. Accordingly, in embodiments, the sensor 210 may not include the sensing coil 211 and may instead, for example, include a device which produces an optical signal.

Referring again to FIG. 1, and with reference to FIGS. 2A-2B, in embodiments, either or both of the sensor assemblies 200A, 200B may be configured as any embodiment of the sensor assembly 200 described herein (for example, the embodiment of FIG. 2A, wherein the sensing target 220 is mechanically coupled to the positioning arm 130, or other embodiments, such as embodiments wherein either the sensor 210 or the sensing target 220 is mechanically coupled to the stage 110 and/or any component thereof). Accordingly, in embodiments, a position of the stage 110 (as modified by, for example, either or both of the motor assemblies 120A, 120B) may be measured by either or both of the sensor assemblies 200A, 200B to, for example, enable an optical device of the microscopy assembly (for example, an objective lens 610, as depicted in FIG. 6 and described elsewhere herein) to be optically coupled to an optical cartridge received by the stage 110 and positioned upon the platform 310.

Referring now to FIG. 3, in embodiments, the stage 110 of the microscopy assembly 100 may include the cartridge holder 320 which may, for example, retain a position (in, for example, any, some, or all of the x-, y-, and/or z-coordinates of the coordinate scheme of FIG. 3) an optical cartridge 305 received by the stage 110 and positioned upon the platform 310.

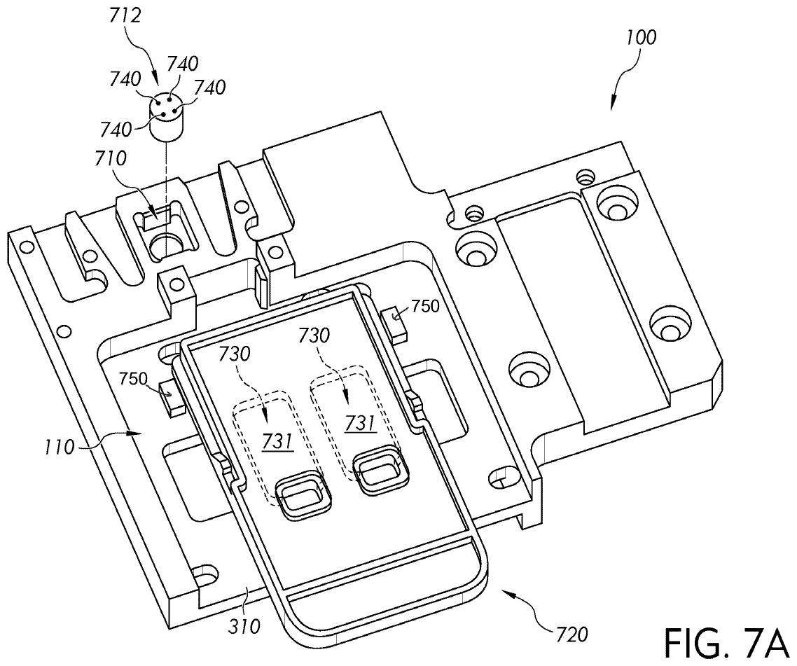

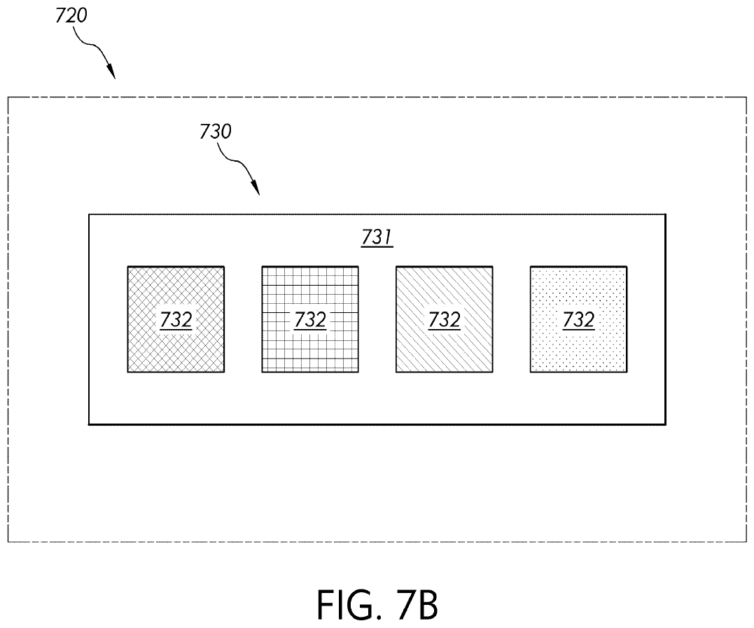

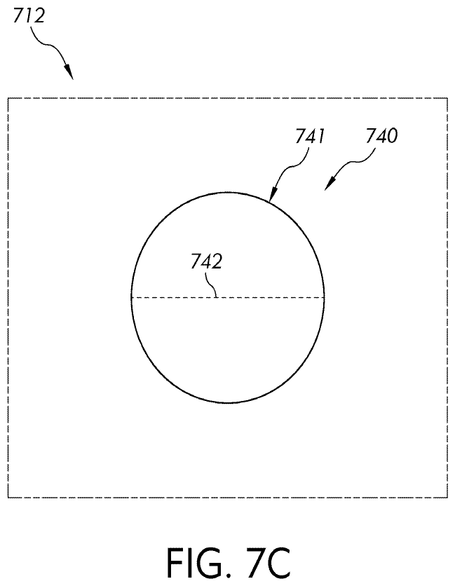

In embodiments, the cartridge holder 320 of the stage 110 includes a pair of retention arms 340A, each defining a retention face 341A and a rounded release face 342A opposite the retention face 341A. In embodiments, the retention face 341A at least partially faces the planar surface 311. In embodiments, when the stage 110 is receiving the optical cartridge 305, the insertion of the optical cartridge 305 may lift the retention arms 340A (for example, in the +z direction of the coordinate scheme of FIG. 3 and away from the platform 310), thereby removing a force exerted (in, for example, the −z direction of the coordinate scheme of FIG. 3 and toward the platform 310) by the retention arms 340A. Particularly, in embodiments, the retention arms 340A may be positioned opposite one another (relative to, for example, the optical cartridge 305) such that the respective retention face 341A of each of the retention arms 340A faces the planar surface 311. Accordingly, in embodiments, when the stage 110 is receiving the optical cartridge 305, the retention face 341A of each of the retention arms 340A engages a respective one of a pair of complementary cartridge engagement surfaces 306A of the optical cartridge 305. In embodiments, a position of the optical cartridge 305 (in the embodiment of FIG. 3, in the z-direction of the coordinate scheme of FIG. 3 and relative to the platform 310, and, in other embodiments, in any, some, or all of the x-, y-, and/or z directions) may thereby be fixed by the retention arms 340A. In some embodiments, one or more hard stops 750 (FIG. 7A) alone or in conjunction with the retention arms 340A restrict movement of the optical cartridge 305 in the x and y directions.

Referring now to FIGS. 3-4, in embodiments, the microscopy assembly 100 may include a heatsink 400 (depicted in FIG. 4). In embodiments, the heatsink 400 may rest within the window 312 and, in embodiments, provide a partially opened surface through which heat may be delivered to and/or emanate from, for example, the optical cartridge 305. In embodiments, the cartridge holder 320 may also include a pair of biased compression members 340B, each of which may, in embodiments, be coupled to the heatsink 400. In embodiments, a position of the heatsink 400 (in, for example, the z-direction of the coordinate schemes of FIGS. 3-4 and relative to the platform 310) may thereby be movable relative to the platform 310 and may, in embodiments and, for example, when the stage 110 has received the optical cartridge 305, define, in a mounting position and collectively with the platform 310, the planar surface 311. In embodiments, the biased compression members 340B may each comprise a heatsink snap 341B, and, in embodiments, the heatsink 400 may comprise a pair of heatsink retention flanges 405. In embodiments, each of the heatsink snaps 341B may be configured to engage a respective one of the heatsink retention flanges 405, thereby coupling the heatsink 400 to the stage 110. In embodiments, the coupling of the biased compression members 340B and the heatsink 400 may bias the heatsink 400 upward (in, for example, the +z direction of the coordinate schemes of FIGS. 3-4), thereby making the heatsink 400 movable in, for example, the +/−z-direction of the coordinate schemes of FIGS. 3-4. In embodiments, the biased compression members 340B may be elastically deformable, thereby, in embodiments, providing the biasing force acting upon the heatsink 400. In embodiments, the biased compression members 340B may be monolithically formed. In embodiments, the heatsink 400 may be formed from a metal (for example, aluminum 6061) and/or any other material(s), such as, for example, materials with high coefficients of thermal expansion. In some embodiments, the heatsink 400 is anodized to restrict scratching or damage from the cartridge 305.

In embodiments, the cartridge holder 320 may include only one, none, or any plurality (such as, for example, three, four, or even five or more) of the retention arms 340A. In embodiments, the cartridge holder 320 may include only one, none, or any plurality (such as, for example, three, four, or even five or more) of the biased compression members 340B. In embodiments, the heatsink 400 may include only one, none, or any plurality (such as, for example, three, four, or even five or more) of the heatsink retention flanges 405. In embodiments, the heatsink 400 may include a number of heatsink retention flanges 405 equal to, greater than, or less than a number of biased compression members 340B and/or a number of heatsink snaps 341B.

In embodiments, the stage 110 may further comprise padding to, for example, prevent damage to the optical cartridge 305 by the biasing of, for example, any, some, or all of the retention arms 340A and/or the biased compression members 340B. Accordingly, in embodiments, the stage 110 may further comprise one or more pads positioned on the planar surface 311 and opposite any, some, or all of the retention faces 341A such that, in embodiments, either or both of the retention arms 340A engage the optical cartridge 305 between the respective retention face 341A of the retention arm 340A and the one or more pads.

In embodiments, the cartridge holder 320 may be integrally formed from the platform 310. However, in other embodiments, the cartridge holder 320 may be mechanically coupled to the platform 310. Accordingly, in embodiments, the cartridge holder 320 may comprise a pair of biased bosses 360 positioned opposite one another and extending laterally relative to the platform 310. In embodiments, the platform 310 may comprise a pair of boss retention members 365, wherein each of the boss retention members 365 is positioned relative to a respective one of the biased bosses 360 such that a laterally-facing compression face 361 of each of the biased bosses 360 engages a respective one of the boss retention members 365. Accordingly, in embodiments, the engagement of the laterally-facing compression faces 361 against the boss retention members 365 may retain a position (in, for example, either or both of the x- and/or y-directions of the coordinate scheme of FIG. 3 and relative to the platform 310) of the cartridge holder 320.

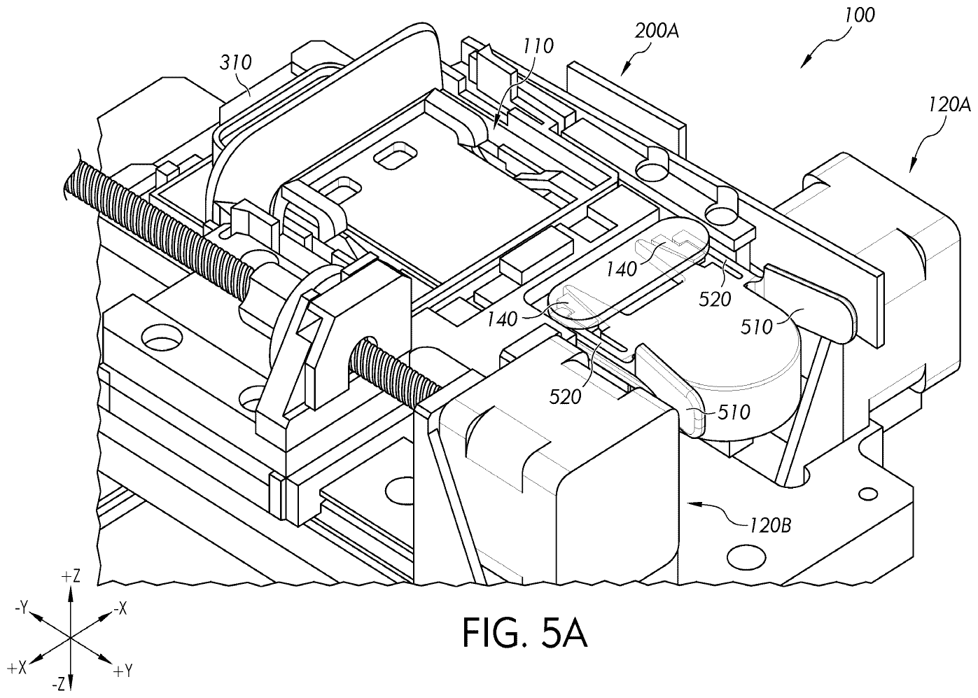

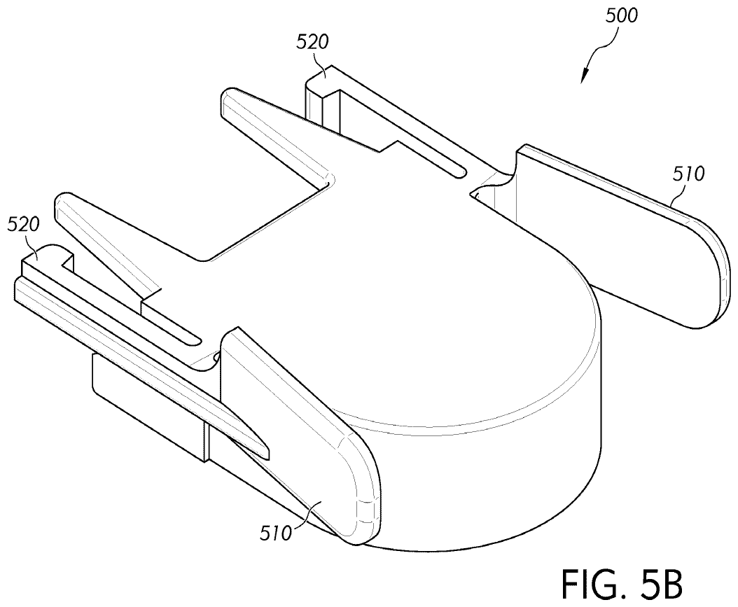

In embodiments, the cartridge holder 320 may be, for example, an injection-molded part. In embodiments, the cartridge holder 320 may be formed from any, some, or all of silicon, an Acetal® polymer, a polycarbonate, a plastic (for example, an acrylonitrile butadiene styrene (“ABS”) plastic), and/or one or more other materials. In embodiments, the cartridge holder 320 may be a monolithic structure. It should be understood that the term “monolithic” as used herein with reference to components refers to a component being formed from a singular part. That is, monolithic structures lack separate parts and/or sub-components and, instead, comprise only a single component. Accordingly, as can be seen in, for example, the embodiment of FIG. 3, the cartridge holder 320 is a monolithic structure at least because all of the sub-components thereof (for example, the retention arms 340A, the biased compression members 340B, the downwardly-extending snap members 350A, 350B, and the biased bosses 360) are formed from the cartridge holder 320 rather than, for example, being mechanically coupled, welded to, or otherwise attached to the cartridge holder 320. Accordingly, assembly of the cartridge holder 320 and/or one or more other components described herein which, in embodiments, may be monolithic structure (such as, for example, the heatsink 410 and/or the objective dust cover, depicted in FIGS. 5A-5B) may, in embodiments, not require assembly of sub-components thereof, as, in embodiments wherein the cartridge holder 320 and/or such other one or more components are monolithic structures, the cartridge holder 320 and/or such other one or more components are monolithic structures and, thereby, each contains no sub-components.

Referring still to FIGS. 3-4, in embodiments, the platform 310 (which is depicted in FIG. 3 in an underneath view) may define a first pair of snap-receiving spaces 313A and a first pair of snap mount surfaces 314A, each of which may be positioned adjacent to a respective one of the first pair of snap-receiving spaces 313A. In embodiments, the platform 310 may further define a second pair of snap-receiving spaces 313B and a second pair of snap mount surfaces 314B, each of which may be positioned adjacent to a respective one of the second pair of snap-receiving spaces 313B.

In embodiments, the cartridge holder 320 may comprise a first pair of downwardly-extending snap members 350A each comprising a first flange 351A, and, in embodiments, each of the first flanges 351A may extend through a respective one of the first pair of snap-receiving spaces 313A and bias the respective first downwardly-extending snap member 350A against a respective one of the first snap mount surfaces 314A. Accordingly, in embodiments, each of the first downwardly-extending snap members 350A may snap into a respective one of the first pair of snap-receiving spaces 313A and, thereafter, fix a position of the cartridge holder 320 (in, for example, the z-direction of FIGS. 3-4 and relative to the platform 310) by moving each of the first pair of flanges 351A through a respective one of the first pair of snap-receiving spaces 313A.

In embodiments, the cartridge holder 320 may comprise a second pair of downwardly-extending snap members 350B each comprising a second flange 351B, and, in embodiments, each of the second flanges 351B may extend through a respective one of the second pair of snap-receiving spaces 313B and bias the respective second downwardly-extending snap member 350B against a respective one of the second snap mount surfaces 314B. Accordingly, in embodiments, each of the second downwardly-extending snap members 350B may snap into a respective one of the second pair of snap-receiving spaces 313B and, thereafter, fix a position of the cartridge holder 320 (in, for example, the z-direction of FIGS. 3-4 and relative to the platform 310) by moving each of the second pair of flanges 351B through a respective one of the second pair of snap-receiving spaces 313B.

In embodiments, the cartridge holder 320 may only comprise only one of the first pair of downwardly-extending snap members 350A or the second pair of downwardly-extending snap members 350B. In embodiments, the cartridge holder 320 may comprise one, none, or any plurality (such as three, four, or even five or more) of either or both of the first downwardly-extending snap members 350A and/or the second downwardly-extending snap members 350B.

In embodiments, via any, some, or all of the biased bosses 360, the first pair of downwardly-extending snap members 350A, and/or the second pair of downwardly-extending snap members 350B, a position of the cartridge holder 320 may be fixed (in, for example, any, some, or all of the x-, y-, or z-directions of the coordinate scheme of FIG. 3) relative to the platform 310. Accordingly, since, in embodiments, the cartridge holder 320 fixes a position of the optical cartridge 305 (as described in further detail above), the optical cartridge 305 may, in embodiments, be fixed in position relative to the platform 310 and/or other components of the microscopy assembly 100 such as, for example, an objective lens 610, depicted in FIG. 6 and described in further detail elsewhere herein) via the cartridge holder 320.

Referring now to FIGS. 5A-5B, in embodiments, the microscopy assembly 100 may further comprise an objective dust cover 500 (depicted in FIGS. 5A-5B). In embodiments, the objective dust cover 500 may be formed from the stage 110. In other embodiments, the objective dust cover 500 may be mechanically coupled to the stage 110, and, in certain such embodiments, the objective dust cover 500 may be removably coupled to the stage 110 (that is to say, the objective dust cover 500 may be decoupled from the stage 110 by, for example, a user). Particularly, in embodiments, the objective dust cover 500 may comprise a pair of compressible removal members 510 and a pair of retention members 520. In embodiments, the stage 110 may comprise a pair of dust cover retaining members 140, and, in embodiments and when the objective dust cover 500 is mechanically coupled to the stage 110, each of the retention members 520 may bias the objective dust cover against a respective one of the dust cover retaining members 140 (by, for example, extending about each of the dust cover retaining members 140), thereby, in embodiments, mechanically coupling the objective dust cover 500 to the stage. In embodiments, the compressible removal members 510 may, when compressed (for example, wherein each of the compressible removal members 510 are pushed toward the other of the compressible removal members 510), separate each of the retention members 520 from the respective one of the dust cover retaining members 140, thereby, in embodiments, decoupling the objective dust cover 500 from the stage 110.

In embodiments, the objective dust cover 500 may be, for example, an injection-molded part. In embodiments, the objective dust cover 500 may be formed from any, some, or all of an elastomer, silicon, ethylene propylene diene monomer (“EPDM”) rubber, polyether block amide (“PEBA”), polyvinyl chloride (“PVC”), thermoplastic elastomer (“TPE”), thermoplastic polyurethane (“TPU”), thermoplastic vulcanizates (“TPV”), liquid silicone rubber (“LSR”), other rubbers, and/or one or more other materials and may be compressible. In embodiments, the objective dust cover 500 may be a monolithic structure.

Referring now to FIG. 6 and with reference to FIGS. 1 and 5A, the microscopy assembly 100 may include an objective lens 610 which, in the depiction of FIG. 6, is optically coupled to the platform 310 in a viewing position. In embodiments, the objective lens 610 may define an imaging path axis 612 extending through the stage 110. Accordingly, the stage 110 may be movable in an imaging plane 620 (for example, parallel to the x/y plane of the coordinate scheme of FIG. 6 and which, for example and referring to FIG. 1, may be defined by or parallel to the planar surface 311 of the platform 310). In embodiments, the stage 110 may be moved (in the embodiment of FIGS. 5A and 6, in the −y direction or, in other embodiments, any, some, or all of the +/−x-, +/−y-, and/or +/−z-direction of the coordinate schemes of FIGS. 5A and 6) between the viewing position (depicted in FIG. 6, wherein the imaging path axis 612 extends through the platform 310) and a covered position, wherein the objective dust cover 500 covers the objective lens 610 (by, for example, the objective dust cover 500 occupying a position, in FIG. 5A, depicted therein as being occupied by the platform 310). Accordingly, in embodiments and when, for example, the microscopy assembly 100 is not in use, the objective lens 610 may be moved from the viewing position to the covered position such that the objective lens 610 may be shielded from dust and/or other particles and/or radiation.

Referring again to FIG. 1 and with reference to FIG. 6, in embodiments, the first sensor 210A of the first sensor assembly 200A may detect a first measurement of the first sensing target 220A. In embodiments, a second sensor of the second sensor assembly 200B may detect a second measurement of a second sensing target of the second sensor assembly 200B. In embodiments, sensors of additional sensor assemblies of the microscopy assembly 100 may detect additional measurements of sensing targets of such sensor assemblies. In embodiments, measurements detected by any, some, or all of the sensor assemblies 200A, 200B and/or other sensor assemblies may be indicative of a position of a stage along a respective axis in the imaging plane 620 of FIG. 6, thereby enabling a position of the platform 310 and/or any optical cartridges positioned thereon to be precisely moved relative to the objective lens 610 (to, for example, focus the objective lens 610 on a particular portion of an optical cartridge positioned upon the platform 310). For example, the first measurement detected by the first sensor 210A of the first sensor assembly 200A is, in the embodiment of FIG. 1, indicative of an x-position of the stage (that is to say, a position of the stage 110 in the x-coordinates of the coordinate schemes of FIGS. 1 and 6). Similarly, the second measurement detected by the second sensor of the second sensor assembly 200B is, in the embodiment of FIG. 1, indicative of a y-position of the stage (that is to say, a position of the stage 110 in the y-coordinates of the coordinate schemes of FIGS. 1 and 6). Accordingly, in embodiments, any, some, or all of the sensor assemblies 200A, 200B, and/or one or more other sensor assemblies of the microscopy assembly 100 may enable the objective lens 610 to precisely image of some or all of an optical cartridge (for example, the optical cartridge 305) positioned upon the platform 310.

However, in embodiments, optical devices of the microscopy assembly 100, such as the objective lens 610 and/or one or more imaging sensor(s) (for example, cameras) optically coupled thereto, may degrade in optical fidelity (for example, in focusing calibration and/or imaging resolution) over time. Accordingly, it may, in embodiments, be desirable for the microscopy assembly 100 to include mechanisms for calibrating and/or testing an imaging resolution of such optical devices. Further, in certain such embodiments, it may be desirable for such mechanisms to be usable (either in actuality or effectively due to, for example, financial constraints associated with the usage of such mechanisms) throughout the lifespan of the microscopy assembly 100 (rather than, for example, only prior to the sale of the microscopy assembly 100.

Referring now to FIG. 7A and with reference to FIGS. 1 and 6, in embodiments, the microscopy assembly 100 may include one or more optical targets which may, in embodiments, be usable for calibrating and/or testing an imaging resolution of optical devices of the microscopy assembly 100. For example, in embodiments, the microscopy assembly 100 may further comprise a printed circuit board assembly and an imaging sensor (not depicted in FIG. 6) optically coupled to the objective lens 610 (by, for example, being positioned along the imaging path axis 612 and below, in the −z-direction, the objective lens 610) and, thereby, optically coupled to one or more optical targets of the microscopy assembly 100. In certain such embodiments, the imaging sensor may, thereby, be enabled to capture an image of an optical target of the microscopy assembly 100, and, using the image, a resolution and/or calibration of the image, the imaging sensor, the objective lens 610, and/or one or more other optical device(s) of the microscopy assembly 100 may be calculated by the printed circuit board. In embodiments, a resolution and/or calibration of the image of the optical target may be compared to a previously-measured resolution to calculate a potential change in resolution, thereby enabling the measurement of a calibration and/or a resolution of optical devices of the microscopy assembly 100 across the lifetime of the microscopy assembly 100.

Referring to FIGS. 7A-7B, in embodiments, an optical target optical cartridge 720 may comprise one or more optical targets 732 positioned upon surfaces 731 of one or more substrates 730 (formed from, for example, glass) of the optical target optical cartridge 720. In embodiments, the optical target optical cartridge 720 may be positionable on the stage 110 such as, for example, in a manner similar to the configuration of the optical cartridge 305 and the stage 110 in the embodiment of FIG. 3. In embodiments, the stage 110 may be movable (by, for example, the motor assemblies 120A, 120B of FIG. 1) from a viewing position (as described elsewhere herein) to an optical target position, wherein the imaging path axis 612 extends through one of the optical targets 732 and/or wherein the objective lens 610 is otherwise optically coupled to one or more of the optical targets 732. Accordingly, in embodiments, the one or more optical targets 732 may enable the measurement of a calibration and/or a resolution of optical devices of the microscopy assembly 100 across the lifetime of the microscopy assembly 100 by simply positioning the optical target optical cartridge 720 upon the platform 310. In embodiments, optical targets positioned upon the substrates 730 may be configured as one or more optical targets 732, which may, in embodiments, be patterns printed upon, engraved into, or otherwise formed from and/or on the substrates 730. In embodiments, the one or more optical targets 732 may be lithographically printed on the surfaces 731 of the substrates 730. In embodiments, the optical targets 732 may be one or more patterns (for example, lithographically printed patterns), and images of the pattern(s) of the optical targets 732 may be compared to previously-taken (for example, after the manufacturing of but before the sale of the microscopy assembly 100) images of the optical targets 732 to measure a calibration and/or resolution of the image and/or one or more optical device(s) of the microscopy assembly 100 to a previously-measured resolution and/or calibration of the previously-taken image and/or one or more optical device(s) of the microscopy assembly 100. Accordingly, in embodiments, the optical target optical cartridge 720 and the optical targets 732 positioned thereupon may be used to measure a resolution and/or calibration of one or more optical device(s) (for example, an imaging sensor and/or the objective lens 610) of the microscopy assembly 100 over the lifetime of the microscopy assembly 100 by, for example, a user of the microscopy assembly 100 retaining the optical target optical cartridge 720 after purchase of the microscopy assembly 100.

In embodiments, the patterns of the optical targets 732 may include any, some, or all of lines, arcs, or other patterns of known measurements (for example, dimensions, angles, curvature, and/or one or more other such qualities) so that measurements, in images of the optical targets 732, of such lines, arcs, and/or other such patterns may be compared against the known measurements to determine a calibration and or resolution of one or more optical device(s) (for example, an imaging sensor and/or the objective lens 610) of the microscopy assembly 100. Such known measurements may be known by being previously measured in, for example, images taken by the optical device(s) of the microscopy assembly 100, for example, after the manufacturing of but before the sale of the microscopy assembly 100. Accordingly, in embodiments, the surface 731 and/or another portion of the optical target optical cartridge 720 may include a unique identifier (comprising, for example, a serial number; formed by, for example, being printed and/or carved into the optical target optical cartridge 720 and/or the substrate 730) so that previously-taken images of the optical targets 732 may be appropriately identified for comparison against newly-taken images of the optical targets 732, thereby avoiding potentially erroneous comparisons of such images.

In the embodiment of FIG. 7A, the optical target optical cartridge 720 includes two substrates 730; however, in other embodiments, the optical target optical cartridge 720 may include one substrate 730 or any plurality of substrates 730, such as three, four, or even five or more substrates 730. In the embodiment of FIG. 7B, the substrate 730 includes 4 optical targets 732; however, in other embodiments, any, some, or all of the substrates 730 of the optical target optical cartridge 720 may comprise one optical target 732 or any plurality of optical targets 732, such as two, three, or even five or more optical targets 732. In the embodiment, of FIG. 732, each of the optical targets 732 comprises a different pattern. However, in other embodiments, any, some, or all of the optical targets 732 may comprise different and/or the same patterns. It should be understood that the depictions of the patterns of the optical targets 732 are purely illustrative, and that, in embodiments, any, some, or all of the optical targets 732 may comprise other patterns having, for example qualities such as those described elsewhere herein.

Referring now to FIG. 7A and with reference to FIGS. 1 and 6, in embodiments, the microscopy assembly 100 may include one or more optical targets configured as pinhole apertures. For example, in the embodiment of FIG. 7A, the stage 110 defines an optical target sample holder 710, into which an optical target sample 712 may be inserted. In embodiments, the optical target sample 712 comprises one or more pinhole apertures 740 and, when the optical target sample 712 is inserted into the optical target sample holder 710, the one or more pinhole apertures 740 may, thereby, be positioned on the stage 110. However, in other embodiments, the optical target sample 712 and the stage 110 may be the same component (for example, a monolithic structure), and, in certain such embodiments, any, some, or all of the pinhole apertures 740 may, thereby, be defined by the stage. In embodiments, the stage 110 may be movable (by, for example, the motor assemblies 120A, 120B of FIG. 1) from a viewing position (as described elsewhere herein) to an optical target position, wherein the imaging path axis 612 extends through the optical target sample 712 and/or wherein the objective lens 610 is otherwise optically coupled to one or more of the pinhole apertures 740.

In the embodiment of FIG. 7A, the optical target sample 712 defines four pinhole apertures 740; however, in other embodiments, either or both of the stage 110 and/or the optical target sample 712 may define one, none, or any plurality (such as, for example, two, three, or even five or more) of the pinhole apertures 740. The pinhole apertures 740 may be formed by, for example, boring holes into the optical target sample 712 and/or the stage 110. In other embodiments, however, the optical target sample 712 and/or the stage 110 may define or otherwise have printed thereon one or more optical targets configured as the optical targets 732. In embodiments, one or more of the optical targets 732 of the optical target optical cartridge 720 may, rather than comprise a pattern, instead comprise a pinhole aperture defined by the optical target optical cartridge 720. In embodiments, the pinhole apertures 740 may be precisely formed such that the optical target sample 712 and/or the stage 110 defines a precise edge of one or more of the pinhole apertures 740, such that images of one or more of the pinhole apertures 740 may, in embodiments, indicate a sharp contrast between one or more of the pinhole apertures 740 and the optical target sample 712 and/or the stage 110.

Referring now to FIG. 7C, a single pinhole aperture 740 of the optical target sample 712 is depicted. In embodiments, the pinhole aperture 740 comprises an edge 741 and a diameter 742. In the embodiment of FIG. 7B, the pinhole aperture 740 comprises a substantially circular shape; however, in other embodiments, the pinhole aperture 740 may comprise any shape, as long as the shape has a precisely slanted and/or curved edge and/or size which may, in an image and as described in further detail below, be used to measure a calibration and/or resolution of an image of an optical device of the microscopy assembly 100. In embodiments, the diameter 742 of the pinhole aperture 740 may be greater than or equal to 20 μm (microns) and less than or equal to 620 μm. In some embodiments, the diameter 742 of the pinhole aperture 740 is about 500 μm.

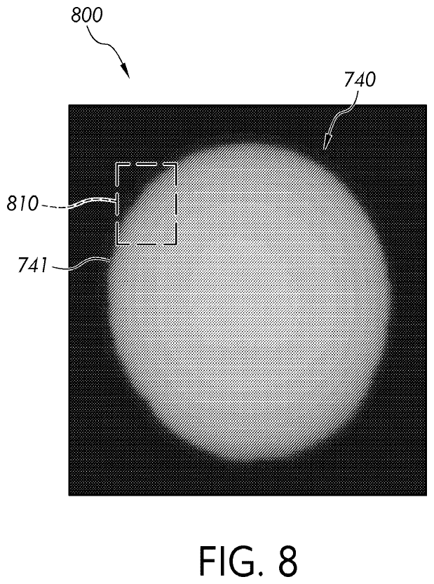

Referring to FIGS. 7C-8 and with reference to FIG. 6, FIG. 8 depicts an image 800 of the pinhole aperture 740 captured by, for example, an imaging device of the microscopy assembly 100 and through the objective lens 610. To measure a resolution and/or calibration of the imaging device and/or another optical device of the microscopy assembly 100 (for example, the objective lens 610), a resolution of the edge 741 in the image 800 may be measured in, for example, a region 810 of the image 800. In embodiments, a resolution of the edge 741 in, for example, the region 810 of the image 800 may be compared to a previously-measured resolution of a region corresponding to the region 810 in a previously-taken image of the pinhole aperture 740, in a manner similar to that described elsewhere herein with respect to usage of the optical targets 732. In embodiments, a resolution of the edge 741 and/or the pinhole aperture 740 in the image 800 may be compared to a known and/or expected value of, for example, an angle of curvature of the edge 741, a magnitude of the diameter 742, or other such measurements of any, some, or all of the pinhole aperture 740 measured at the time of and/or by the process of the formation of the pinhole aperture 740 in the optical target sample 712 and/or the stage 110. Accordingly, in embodiments, the pinhole aperture 740 may, by being defined by the optical target sample 712 and/or the stage 110, be used to measure a resolution and/or calibration of one or more optical device(s) (for example, an imaging sensor and/or the objective lens 610) of the microscopy assembly 100 over the lifetime of the microscopy assembly 100.

In embodiments, a resolution of the image 800 may be calculated by a modulation transfer function (“MTF”). In embodiments, an MTF may use the edge 741 of the pinhole aperture 740 in the image 800 to calculate a resolution (for example, in the region 810 and/or in one or more other region(s) including some or all of the edge 741) of the image 800. By being precisely formed with a sharp transition at the edge 741, the resolution of the edge 741 in the image 800 may be compared against an expected resolution or measurement of the edge 741 (from, for example a measurement of a previously-taken image of the edge 741 and/or a known measurement, such as an angle of curvature, of the edge 741 recorded at and/or by the process by which the pinhole aperture 740 was formed) thereby indicating a calibration and/or resolution of the image 800 and/or one or more optical devices of the microscopy assembly 100 (for example, an imaging sensor and/or the objective lens 610).

Referring now to FIGS. 7A-7C, in embodiments, the microscopy assembly 100 may include and/or otherwise use any combination of one, none, or any plurality of either or both of the pinhole apertures 740 and or the optical targets 732 positioned on and/or defined by any, some, or all of the stage 110, the optical target optical cartridge 720, and/or the optical target sample 712.

It should now be understood that the present disclosure relates to various microscopy assemblies that include any, some, or all of a stage having a retention arm and a pair of biased compression members, an optical target, an objective dust cover, and/or a sensor and a sensing target.

Further aspects of the embodiments described herein are provided by the subject matter of the following clauses:

A microscopy assembly comprising: a stage for receiving an optical cartridge, the stage comprising: a platform defining a planar surface and a window extending through the platform, and a retention arm defining a retention face and a rounded release face opposite the retention face, wherein the retention face at least partially faces the planar surface of the platform and is configured to engage a complementary cartridge engagement surface of the optical cartridge inserted into the microscope assembly.

The microscopy assembly of any preceding clause, further comprising a pad positioned on the platform and facing the retention face, wherein the retention face is configured to engage the optical cartridge between the retention face and the pad.

The microscopy assembly of any preceding clause, wherein the stage further comprises a pair of boss retention members and a pair of biased bosses opposite one another, each of the biased bosses extending laterally relative to the platform and comprising a laterally-facing compression face that engages a respective boss retention member of the pair of boss retention members.

The microscopy assembly of any preceding clause, wherein: the platform defines: a first pair of snap-receiving spaces and a first snap mount surface positioned adjacent to each of the first snap-receiving spaces, and a second pair of snap-receiving spaces and a second snap mount surface positioned adjacent to each of the second snap-receiving spaces; and the stage further comprises: a first pair of downwardly-extending snap members each comprising a first flange, each flange extending through a respective snap-receiving space of the first pair of snap-receiving spaces and biasing the first downwardly-extending snap member against the first snap mount surface of the respective snap-receiving space, and a second pair of downwardly-extending snap members each comprising a second flange, each flange extending through a respective snap-receiving space of the second pair of snap-receiving spaces and biasing the second downwardly-extending snap member against the second snap mount surface of the respective snap-receiving space.

The microscopy assembly of any preceding clause, further comprising a heatsink coupled to the stage, wherein: the stage further comprises a biased compression member including a heatsink snap; the heatsink comprises a heatsink retention flange; the heatsink retention snap is configured to engage the heatsink retention flange and couple the heatsink to the stage.

The microscopy assembly of any preceding clause, wherein the heatsink is movably coupled to the stage such that the heatsink can move between a plurality of positions including a mounting position, wherein the heatsink and the platform define the planar surface.

A microscopy assembly comprising: a stage for receiving an optical cartridge, the stage comprising: a platform defining a planar surface and a window extending through the platform, and a retention arm defining a retention face and a rounded release face opposite the retention face, wherein the retention face at least partially faces the planar surface of the platform and is configured to engage a complementary cartridge engagement surface of the optical cartridge inserted into the microscope assembly; and an optical target.

The microscopy assembly of any preceding clause, further comprising an objective lens optically coupled to the stage, wherein: the objective lens defines an imaging path axis extending through the stage; the stage is movable in an imaging plane transverse to the imaging path axis; the stage is movable between an optical target position and a viewing position; when the stage is in the optical target position, the imaging path axis extends through the optical target; and when the stage is in the viewing position, the imaging path axis extends through the platform of the stage.

The microscopy assembly of any preceding clause, further comprising: a printed circuit board assembly; and an imaging sensor optically coupled to the optical target and electrically coupled to the printed circuit board assembly.

The microscopy assembly of any preceding clause, wherein: the printed circuit board assembly receives an image of the optical target from the imaging sensor; and the printed circuit board assembly calculates a resolution of the image of the optical target.

The microscopy assembly of any preceding clause, wherein the printed circuit board assembly compares the resolution of the image of the optical target to a previously-measured resolution to calculate a potential change in resolution.

The microscopy assembly of any preceding clause, wherein the optical target comprises a pinhole aperture positioned on the stage.

The microscopy assembly of any preceding clause, wherein the pinhole aperture comprises a diameter greater than or equal to 20 μm and less than or equal to 620 μm.

The microscopy assembly of any preceding clause, wherein the pinhole aperture is defined by the stage.

The microscopy assembly of any preceding clause, wherein the optical target comprises a plurality of pinhole apertures.

The microscopy assembly of any preceding clause, further comprising: a printed circuit board assembly; and an imaging sensor optically coupled to the optical target and electrically coupled to the printed circuit board assembly.

The microscopy assembly of any preceding clause, wherein: the printed circuit board assembly receives an image of the pinhole aperture from the imaging sensor; and the printed circuit board assembly calculates a resolution of the image of the pinhole aperture.

The microscopy assembly of any preceding clause, wherein the printed circuit board assembly uses a modulation transfer function to calculate the resolution of the image of the pinhole aperture.

The microscopy assembly of any preceding clause, wherein the modular transfer function uses an edge of the pinhole aperture in the image of the pinhole aperture to calculate the resolution of the image of the pinhole aperture.

The microscopy assembly of any preceding clause, wherein the printed circuit board assembly compares the resolution of the image of the pinhole aperture to a previously-measured resolution to calculate a potential change in resolution.

The microscopy assembly of any preceding clause, further comprising an optical target optical cartridge, the optical target optical cartridge comprising the optical target, wherein the optical target optical cartridge is positionable on the stage.

The microscopy assembly of any preceding clause, wherein the optical target is integrally formed from the stage.

The microscopy assembly of any preceding clause, wherein the stage comprises a sample holder and the optical target is mounted to the sample holder.

The microscopy assembly of any preceding clause, wherein the optical target comprises a glass substrate having a pattern printed on a surface of the glass substrate.

The microscopy assembly of any preceding clause, wherein the pattern is a lithographically printed pattern.

The microscopy assembly of any preceding clause, wherein the optical target comprises a unique identifier.

A microscopy assembly comprising: a stage for receiving an optical cartridge, the stage comprising: a platform defining a planar surface and a window extending through the platform, and a retention arm defining a retention face and a rounded release face opposite the retention face, wherein the retention face at least partially faces the planar surface of the platform and is configured to engage a complementary cartridge engagement surface of the optical cartridge inserted into the microscope assembly; and an objective dust cover coupled to the stage.

The microscopy assembly of any preceding clause, further comprising an objective lens optically coupled to the stage, wherein: the objective lens defines an imaging path axis extending through the stage; the stage is movable in an imaging plane transverse to the imaging path axis; the stage is movable between a covered position and a viewing position; when the stage is in the covered position, the objective dust cover covers the objective lens; and when the stage is in the viewing position, the imaging path axis extends through the platform of the stage.

The microscopy assembly of any preceding clause, wherein the objective dust cover is a monolithic structure.

The microscopy assembly of any preceding clause, wherein the objective dust cover is formed from silicon, ethylene propylene diene monomer rubber, polyether block amide, polyvinyl chloride, thermoplastic elastomer, thermoplastic polyurethane, thermoplastic vulcanizates, liquid silicone rubber, or any combination thereof.

The microscopy assembly of any preceding clause, wherein the objective dust cover is removably coupled to the stage.

The microscopy assembly of any preceding clause, wherein: the objective dust cover comprises one or more compressible removal members and one or more retention members; the stage comprises one or more dust cover retaining members; each of the one or more retention members bias the objective dust cover against a respective dust cover retaining member of the one or more dust cover retaining members; and when the one or more compressible removal members are compressed, each of the one or more retention members are separated from the respective dust cover retaining members of the one or more dust cover retaining members.

A microscopy assembly comprising: a stage for receiving an optical cartridge, the stage comprising: a platform defining a planar surface and a window extending through the platform, and a retention arm defining a retention face and a rounded release face opposite the retention face, wherein the retention face at least partially faces the planar surface of the platform and is configured to engage a complementary cartridge engagement surface of the optical cartridge inserted into the microscope assembly; a sensor; and a sensing target, wherein: one of the sensor and the sensing target is fixed to the stage, and the other of the sensor and the sensing target is spaced apart from the stage.

The microscopy assembly of any preceding clause, wherein the sensor is an inductance sensor.

The microscopy assembly of any preceding clause, wherein the sensor detects a measurement of the sensing target, and wherein the measurement is indicative of a position of the stage.

The microscopy assembly of any preceding clause, further comprising a temperature sensor configured to measure a temperature of the sensor.

The microscopy assembly of any preceding clause, wherein: the sensing target comprises a lateral face extending from a first end of the sensing target to a second end of the sensing target opposite the first end; the sensor and sensing target define a sensing axis extending between the sensor and the lateral face of the sensing target; and one of the sensor and the sensing target is movable relative to the other of the sensor and the sensing target such that the sensing axis is movable between the first end of the sensing target and the second end of the sensing target.

The microscopy assembly of any preceding clause, wherein the lateral face comprises a slope relative to the sensor.

The microscopy assembly of any preceding clause, wherein the lateral face comprises a stepwise gradient relative to the sensor.

The microscopy assembly of any preceding clause, wherein the sensing target comprises a triangular geometry.

The microscopy assembly of any preceding clause, wherein: the sensor is a first sensor and the sensing target is a first sensing target; the microscopy assembly further comprises a second sensor and a second sensing target; and one of the second sensor and the second sensing target is fixed to the stage, and the other of the second sensor and the second sensing target is spaced apart from the stage.

The microscopy assembly of any preceding clause, wherein: the first sensor detects a first measurement of the first sensing target; the second sensor detects a second measurement of the second sensing target; and the first measurement and the second measurement are indicative of a position of the stage.

The microscopy assembly of any preceding clause, further comprising an objective lens optically coupled to the stage, wherein: the objective lens defines an imaging path axis extending through the stage; the stage is movable in an imaging plane transverse to the imaging path axis; the first measurement is indicative of an x-position of the stage along an x-axis of the imaging plane; and the second measurement is indicative of a y-position of the stage along a y-axis of the imaging plane.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A microscopy assembly comprising:
a stage for receiving an optical cartridge, the stage comprising:
a platform defining a planar surface and a window extending through the platform, and
a retention arm defining a retention face and a rounded release face opposite the retention face, wherein the retention face at least partially faces the planar surface of the platform and is configured to engage a complementary cartridge engagement surface of the optical cartridge inserted into the microscope assembly.

2. The microscopy assembly of claim 1, further comprising a pad positioned on the platform and facing the retention face, wherein the retention face is configured to engage the optical cartridge between the retention face and the pad.

3. The microscopy assembly of claim 1, wherein the stage further comprises a pair of boss retention members and a pair of biased bosses opposite one another, each of the biased bosses extending laterally relative to the platform and comprising a laterally-facing compression face that engages a respective boss retention member of the pair of boss retention members.

4. The microscopy assembly of claim 1, wherein:
the platform defines:
a first pair of snap-receiving spaces and a first snap mount surface positioned adjacent to each of the first snap-receiving spaces, and
a second pair of snap-receiving spaces and a second snap mount surface positioned adjacent to each of the second snap-receiving spaces; and
the stage further comprises:
a first pair of downwardly-extending snap members each comprising a first flange, each flange extending through a respective snap-receiving space of the first pair of snap-receiving spaces and biasing the first downwardly-extending snap member against the first snap mount surface of the respective snap-receiving space, and
a second pair of downwardly-extending snap members each comprising a second flange, each flange extending through a respective snap-receiving space of the second pair of snap-receiving spaces and biasing the second downwardly-extending snap member against the second snap mount surface of the respective snap-receiving space.

5. The microscopy assembly of claim 1, further comprising a heatsink coupled to the stage, wherein:
the stage further comprises a biased compression member including a heatsink snap;
the heatsink comprises a heatsink retention flange;
the heatsink retention snap is configured to engage the heatsink retention flange and couple the heatsink to the stage.

6. The microscopy assembly of claim 5, wherein the heatsink is movably coupled to the stage such that the heatsink can move between a plurality of positions including a mounting position, wherein the heatsink and the platform define the planar surface.

7. A microscopy assembly comprising:
a stage for receiving an optical cartridge, the stage comprising:
a platform defining a planar surface and a window extending through the platform, and
a retention arm defining a retention face and a rounded release face opposite the retention face, wherein the retention face at least partially faces the planar surface of the platform and is configured to engage a complementary cartridge engagement surface of the optical cartridge inserted into the microscope assembly; and
an optical target.

8. The microscopy assembly of claim 7, further comprising an objective lens optically coupled to the stage, wherein:
the objective lens defines an imaging path axis extending through the stage;
the stage is movable in an imaging plane transverse to the imaging path axis;
the stage is movable between an optical target position and a viewing position;
when the stage is in the optical target position, the imaging path axis extends through the optical target; and
when the stage is in the viewing position, the imaging path axis extends through the platform of the stage.

9. The microscopy assembly of claim 7, further comprising:
a printed circuit board assembly; and
an imaging sensor optically coupled to the optical target and electrically coupled to the printed circuit board assembly.

10. The microscopy assembly of claim 9, wherein:
the printed circuit board assembly receives an image of the optical target from the imaging sensor; and
the printed circuit board assembly calculates a resolution of the image of the optical target.

11. The microscopy assembly of claim 10, wherein the printed circuit board assembly compares the resolution of the image of the optical target to a previously-measured resolution to calculate a potential change in resolution.

12. The microscopy assembly of claim 7, wherein the optical target comprises a pinhole aperture positioned on the stage.

13. The microscopy assembly of claim 12, wherein the pinhole aperture comprises a diameter greater than or equal to 20 μm and less than or equal to 620 μm.

14. The microscopy assembly of claim 12, wherein the pinhole aperture is defined by the stage.

15. The microscopy assembly of claim 12, wherein the optical target comprises a plurality of pinhole apertures.

16. The microscopy assembly of claim 12, further comprising:
a printed circuit board assembly; and
an imaging sensor optically coupled to the optical target and electrically coupled to the printed circuit board assembly.

17. The microscopy assembly of claim 16, wherein:
the printed circuit board assembly receives an image of the pinhole aperture from the imaging sensor; and
the printed circuit board assembly calculates a resolution of the image of the pinhole aperture.

18. The microscopy assembly of claim 17, wherein the printed circuit board assembly uses a modulation transfer function to calculate the resolution of the image of the pinhole aperture.

19. The microscopy assembly of claim 18, wherein the modular transfer function uses an edge of the pinhole aperture in the image of the pinhole aperture to calculate the resolution of the image of the pinhole aperture.

20. The microscopy assembly of claim 17, wherein the printed circuit board assembly compares the resolution of the image of the pinhole aperture to a previously-measured resolution to calculate a potential change in resolution.
